(19) United States
(12) Patent Application Publication
(10) Pub. No.: US 2008/0047411 A1
(43) Pub. Date: Feb. 28, 2008

(54) Saw

(76) Inventor: Yang Cao, Nanjing (CN)

Correspondence Address: MCDERMOTT, WILL & EMERY LLP, 227 WEST MONROE STREET, SUITE 4400, CHICAGO, IL, 60606-5096, US

(21) Appl. No.: 11/894,983

(22) Filed: Aug. 22, 2007

(30) Foreign Application Priority Data
Aug. 23, 2006 (CN) 200620076931.0

(51) Int. Cl. B26D 5/00

(52) U.S. Cl. 83/829

(57) ABSTRACT

A table-top saw comprises a base, frame, water pan and a table disposed with the frame for supporting a workpiece to be cut. The saw also includes a guide beam and a carriage operably connected to the guide beam by a fixing mechanism, wherein the carriage is capable of slidable movement along the guide beam. A cutter-motor unit, including a saw and motor, is secured to the carriage whereby the cutter-motor unit is slidable along the guide beam. The fixing mechanism includes a trig block for locking the carriage and the cutter-motor unit at a selected position on the guide beam. The fixing mechanism is movable between a released position wherein a clearance is defined between a lower surface of the guide beam and the trig device to allow for movement along the guide beam, and a locked position wherein the trig device engages the lower surface of the guide beam. The fixing mechanism further includes a rotatable rod that extends through a slot in the trig block and a hole in the carriage, wherein an upper end of the rod includes an eccentric wheel and a lower end of the rod includes a handle that is actuated by an operator to move the fixing mechanism between the released and locked positions.

### CROSS-REFERENCE TO RELATED APPLICATION

This application claims priority under 35 U.S.C. § 119 of Chinese Application 200620076931.0, filed Aug. 23, 2006, which is hereby incorporated by reference.

### FEDERALLY SPONSORED RESEARCH OR DEVELOPMENT

Not Applicable.

### TECHNICAL FIELD

The present invention relates to a table-top saw assembly with a circular saw blade. Specifically, the table-top saw has a fixing mechanism with a trig device for locking the saw at a selected position on the guide beam.

### BACKGROUND OF THE INVENTION

Conventional table-top saws comprise a support bed and a guide beam arranged transversely above and connected to the support bed by two upright members, where one end of each upright member is fixed to the guide beam. The guide beam together with the two upright members constitutes a bridge structure. A cutter-motor unit is fixed to a carriage which is capable of moving along the guide beam by means of bearings. These table-top saws typically do not have a locking device for locking the cutter-motor unit to the guide beam at a selected position. When a plunge cutting operation is desired to be performed at a certain position, the operator has to fix the cutter-motor unit on that position with one hand and then do cutting operation with the other hand, which results in the disadvantages of low accuracy and instability of cutting. While some saws have locking devices, the cutter-motor unit can merely be locked to a limited number of pre-selected special positions along the guide beam, for example, only at the ends of the guide beam, and not at any position along the guide beam.

The present invention is provided to solve these limitations and to provide advantages and aspects not provided by conventional power tools, including circular saws. A full discussion of the features and advantages of the present invention is deferred to the following detailed description, which proceeds with reference to the accompanying drawings.

### SUMMARY OF THE INVENTION

An object of the present invention is to provide a table-top saw with a fixing mechanism which an operator can actuate to lock the cutter-motor unit to the guide beam, whereby it is easy and convenient to lock the cutter-motor unit to any position along the guide beam via the fixing mechanism without using other tools.

To achieve this objective, a table-top saw according the present invention comprises a frame, a table disposed on or formed on the frame for supporting a workpiece to be cut, two upright members connected to two ends of the frame, a horizontal guide beam extending between the upright members, a carriage configured to slide along the guide beam, a cutter-motor unit fixed to the carriage, and a fixing mechanism capable of locking the carriage to the guide beam. The fixing mechanism further comprises a trig device and an actuator which moves the trig device between a first or released position and a second or locked position. The trig device has a brake which does not contact the guide beam in the released position, and that firmly engages the guide beam in the secured position to lock the motor-cutter at a desired position on the guide beam.

This fixing mechanism for quickly locking the cutter-motor unit disclosed in the present invention overcomes the disadvantages of the bolts and nuts locking device of prior art, which wastes time and can not achieve the locking operation at any position along the guide beam. The locking of the cutter-motor unit by means of the contact between the trig brake and the guide beam is convenient, is not time consuming, and does not require the use of any other tools.

### BRIEF DESCRIPTION OF THE DRAWINGS

The advantages and novel features of the present invention will become apparent from the following detailed description of the preferred embodiment of the invention illustrated in the accompanying drawings, wherein:

FIG. 1 is a perspective view of a saw of the preferred embodiment of the present invention;

FIG. 2 is a partial exploded view of the saw of FIG. 1, showing a guide beam, a carriage, and a cutter-motor unit in a released position;

FIG. 3 is a partial exploded view of the carriage and the fixing mechanism of the saw in FIG. 1 at a released position;

FIG. 4 is an assembled view of the carriage and the fixing mechanism separated from the guide beam;

FIG. 5 is a perspective view of a trig block and the fixing mechanism in the released position;

FIG. 6 is a partial cross-sectional view of the carriage, the trig block and the guide beam in the released position;

FIG. 7 is a partial exploded view of the saw of FIG. 1, showing the carriage and the fixing mechanism in a locked position;

FIG. 8 is a partial exploded view of the carriage and the fixing mechanism in the locked position;

FIG. 9 is a perspective view of the trig block and the fixing mechanism in the locked position;

FIG. 10 is a partial cross-sectional view of carriage, the trig block and the guide beam in the locked position; and,

FIG. 11 is a perspective view of a shaft received by the trig block shown in FIGS. 5 and 9.

### DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

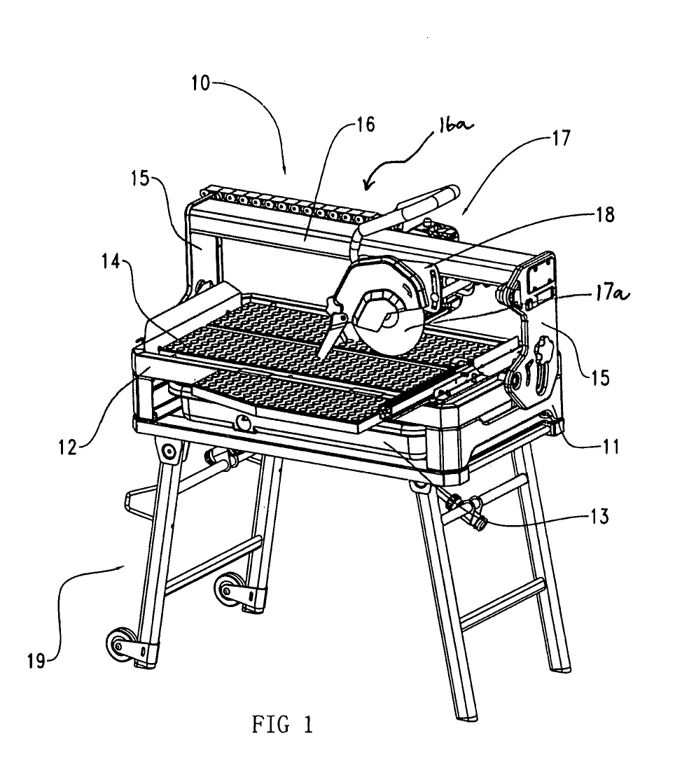

FIG. 1 illustrates a saw assembly 10 of the preferred embodiment of the present invention. The saw 10 comprises a base 11, a frame 12, a water pan 13 disposed below the frame 12, and a table 14 disposed substantially within the frame 12 for supporting a workpiece to be cut. The saw 10 further comprises an upright support arms 15 connected to two ends of the frame 12, and a substantially horizontal guide beam 16 connected at its ends to the other ends of the support arms 15 so as to form a bridge structure 16a. A carriage 18 is movably connected along the guide beam 16, and a cutter-motor unit 17 is supported by the carriage 18. The unit 17 includes a saw blade 17a and motor for driving the saw blade 17a. In the preferred embodiment, the saw 10 can be placed on a stand 19 to perform the cutting operation.

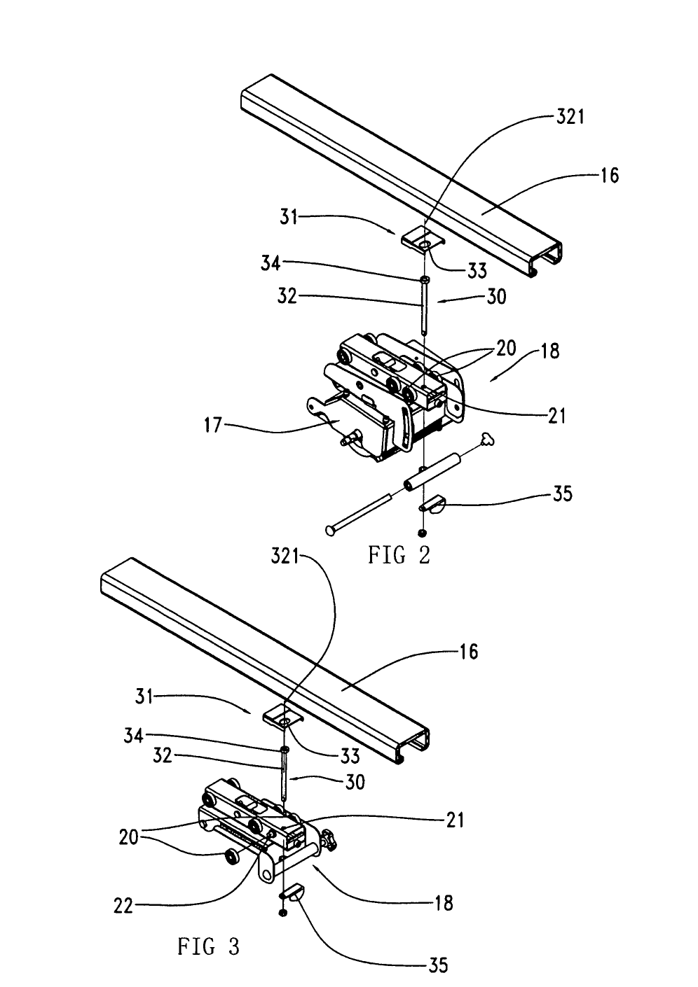

FIGS. 2 and 3 are partially exploded views that depict the guide beam 16, the carriage 18 and the cutter-motor unit 17. Preferably, the cutter-motor unit 17 is fixed to the carriage 18 by screws. The carriage 18, together with the cutter-motor unit 17, slides along the guide beam 16 with the aid of sliding means, such as bearings 20 mounted on shaft 22. Referring to FIGS. 2 and 3, the guide beam 16 defines an elongated cavity that receives the rotatable bearings 20 for sliding movement of the carriage 18 and the cutter-motor unit 17. The cutter-motor unit 17 is fixed to the carriage 18, so that fixing the carriage 18 to the guide beam 16 results in the coupling of the cutter-motor unit 17 to the beam 16. The saw 10 further includes a fixing mechanism 30 for locking the carriage 18 at a selected position on the guide beam 16. The fixing mechanism 30 comprises a trig block 31 having an elongated slot 33 with a longitudinal axis that is perpendicular to the guide beam's longitudinal axis, and a rod 32 having an axis 321. Referring to FIG. 11, an eccentric wheel 34 is mounted to one end of the rod 32, preferably the upper end of the rod 32, and a handle assembly 35 is mounted to other end of the rod 32, preferably the lower end. The wheel 34 has a large radius portion 34a and a small radius portion 34b. As explained below, when rotating the handle 35, the rod 32 is rotated so that the eccentric wheel 34 is rotated in the elongated slot 33 about the axis 321.

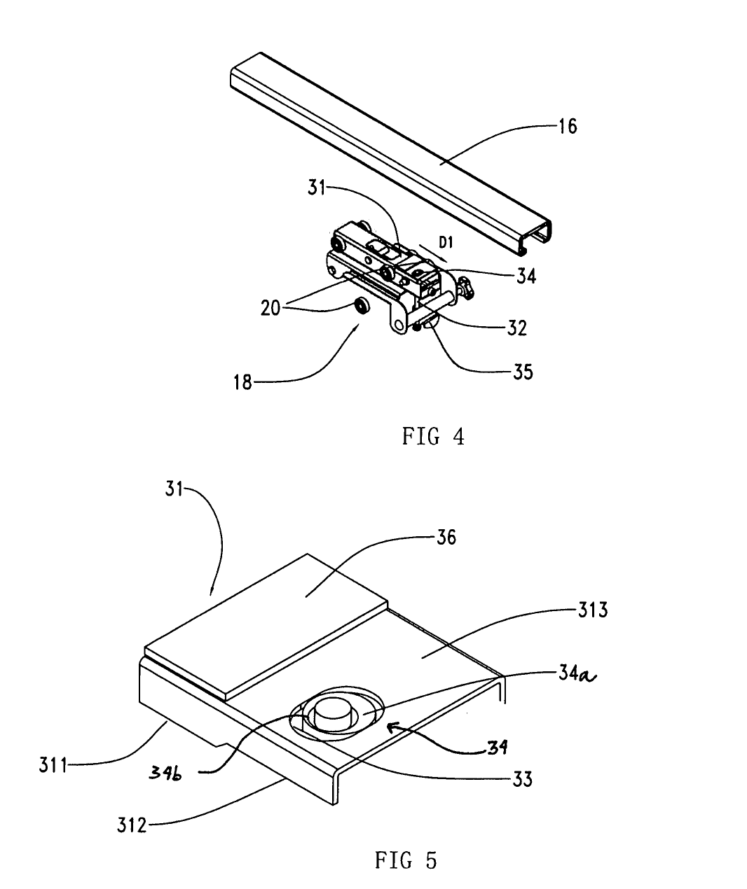

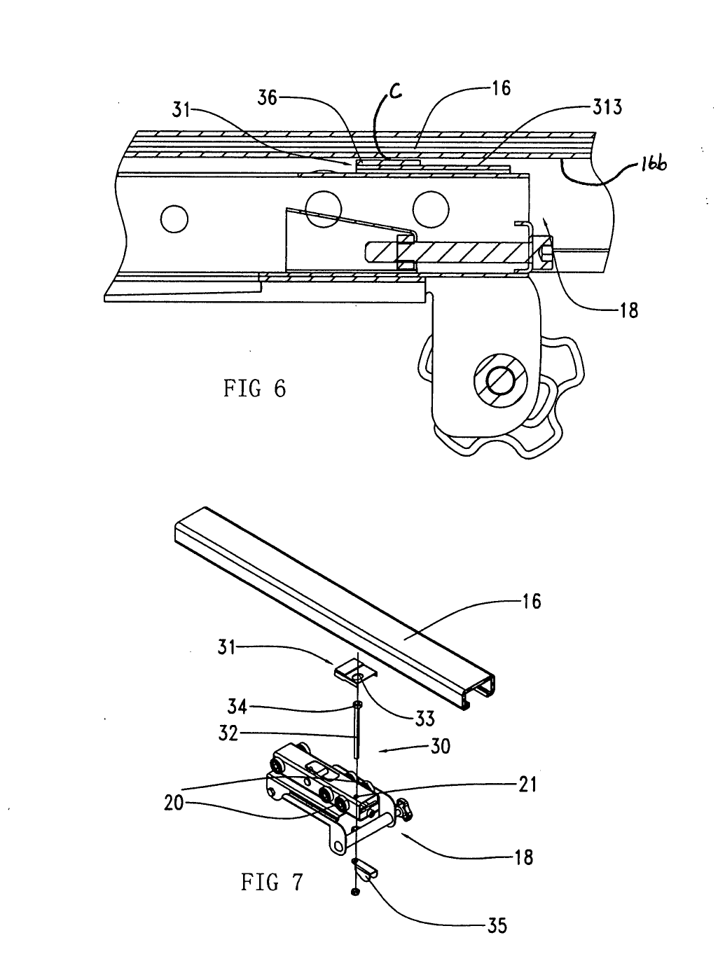

FIGS. 3-6 show the fixing mechanism 30 in a released position, wherein the carriage 18 and the motor unit 17 are slidable along the guide beam 16. The rod 32 operates within the carriage 18, passing through a hole 21 therein. With the aid of the bearings 20, the trig block 31 slides along the shaft 22 in the direction of arrow D1 (shown in FIG. 4), parallel to the longitudinal axis of the guide beam 16. As shown in FIGS. 4-5, the trig block 31 has edges 311, 312 which slide along the shaft 22. The first edge 311 and the second edge 312 do not lie in a same plane, whereupon there is a difference of height between a first edge 311 and a second edge 312, and the vertical height between the first edge 311 and the top surface 313 of the trig block is greater than that between the second edge 312 and the top surface 313. Described in a different manner, the first and second edges 311, 312 are staggered and not aligned with each other. FIG. 4 shows that when the fixing mechanism 30 is at the released position, the second edge 312 contacts the shaft(s) 22. At the same time, as shown in FIG. 5, the larger radius portion 34a of the eccentric wheel 34 is aligned with a longitudinal axis of the slot 33 in the trig block 31. Thus, the eccentric wheel 34 applies no force to the trig block 31 along the longitudinal direction of the guide beam. The trig block 31 also includes a brake, such as rubber segment 36, mounted on the top surface 313, substantially above the first edge part 311, for engagement with the guide beam 16. While the fixing mechanism 30 is in the released position, clearance C (see FIG. 6) is found between the top surface of rubber segment 36 and the bottom surface 16b of the guide beam 16, such that the carriage 18 is not locked to the guide beam 16 and the carriage 18 supporting the cutter-motor unit 17 is capable of sliding movement along the guide beam 16.

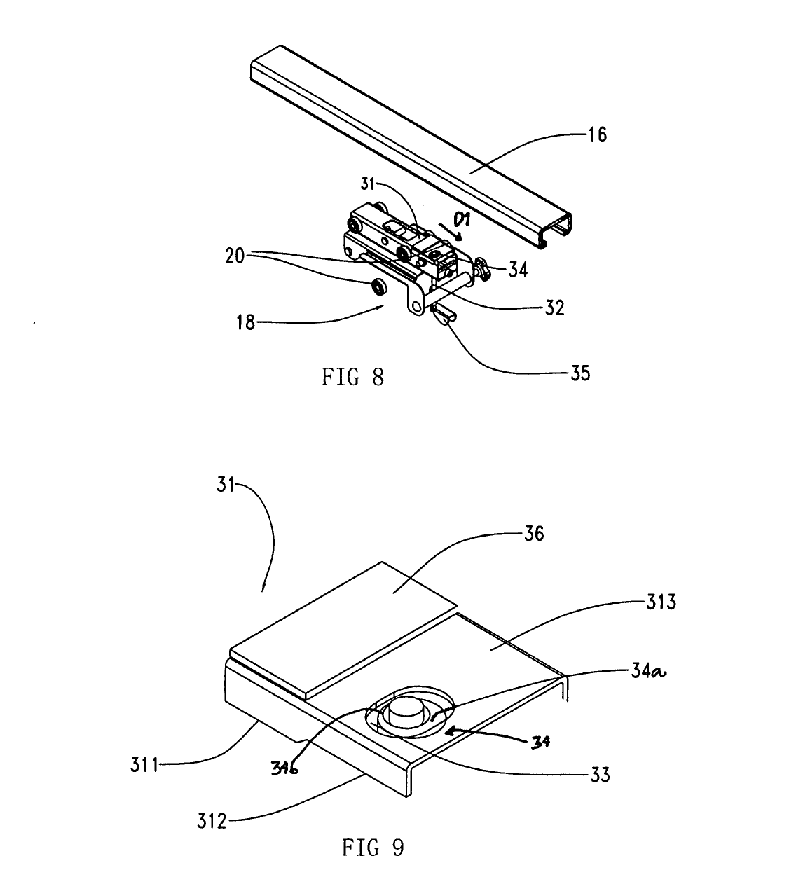

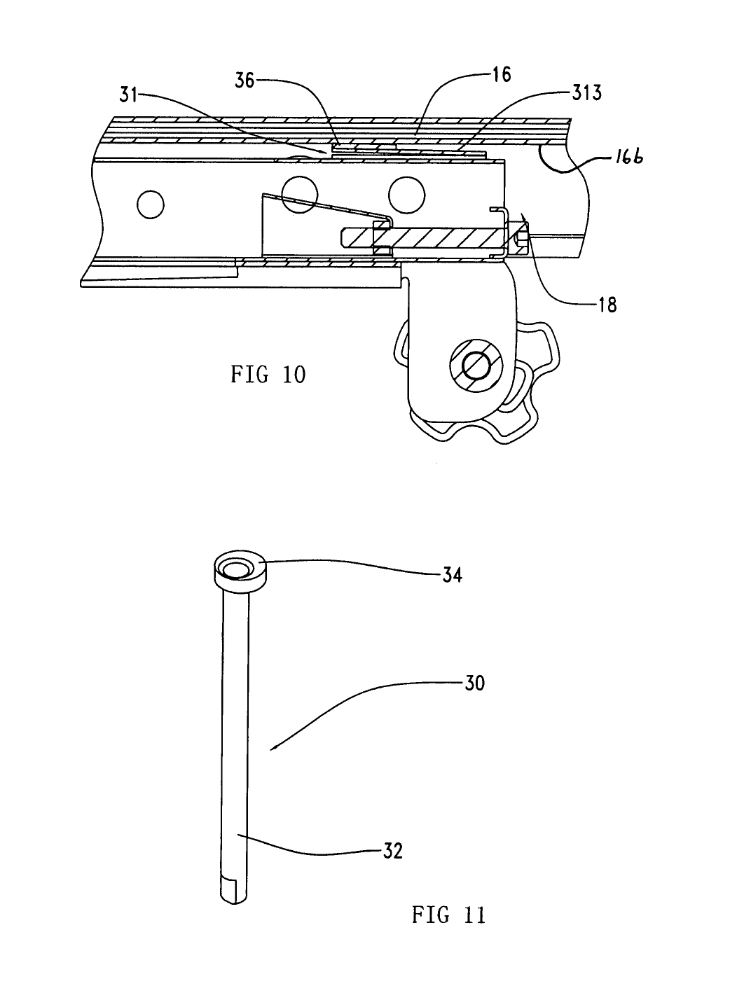

FIGS. 7-10 show the fixing mechanism 30 in a locked position. By rotating the handle 35, preferably 90 degrees, from the released position (of FIGS. 3-6) the carriage 18 can be locked to the guide beam 16. The rod 32 rotates along with the rotation of the handle 35, with a result of the eccentric wheel 34 rotating in the slot 33 about the axis 321. As the larger radius portion 34a of the eccentric wheel 34 is rotated perpendicular to the longitudinal axis of the slot and to contact the long side wall of the slot 33 in trig block 31, the eccentric wheel 34 provides a moving or driving force onto the trig block 31 to move it along the direction of arrow D1 and towards the rod 32 (see FIG. 8). Thus the large radius portion 34a of the eccentric wheel 34 is rotated to a direction parallel to longitudinal axis of the guide beam 16, so that the trig block 31 is driven or moved along the direction of arrow D1. Preferably, once the rotation of the rod 32 is complete, the larger radius portion 34a of the wheel 34, resides below the edge of the slot 33 in the trig block 31. Imparting the driving force on the trig block 31 results in the first edge 311 contacting shaft 22 and the rubber segment 36 being lifted upward relative to the shaft 22 and towards the guide rail 16. Therefore, as shown in FIG. 10, the top surface of the rubber segment 36 touches the bottom surface 16b of the guide beam 16, so that the carriage 18 engages the guide beam 16. This engagement eliminates the clearance C of the released position shown in FIG. 6. Further, the engagement between the rubber segment 36 and the guide rail 16 results in the cutter-motor unit 17 being locked to the guide beam 16. FIG. 9 schematically shows the eccentric wheel 34 engaging the trig block 31 for the locked position.

The above described preferred embodiments are intended to illuminate the principle and spirit of the present invention, but not to limit its scope. Regarding the first and second edges 311, 312 of the block 31, it can be easily understood by those skilled in the art that, instead of two edges in two planes with a height difference existing there between, as disclosed above, in other embodiments, the first edge and the second edge can also be parts of a curved edge which has a height difference. The rubber segment 36 mounted on the trig block 31 can also be replaced by other elastic elements suitable for engagement with the guide rail in other embodiments of the present invention. Furthermore, it is not necessary to use the rubber segment 36 if a locking effect can be ensured when the locking or releasing of the carriage is achieved by directly pressing the top surface of the trig block 31 against the bottom surface 16b of the guide beam 16 or loosing the top surface there from. Those of ordinary skill in the art will understand that many other modifications and variations of the present invention are apparent and may be made without departing from the spirit and the scope of the present invention as defined in the following claims.

What is claimed is:

1. A table-top saw assembly comprising:
a guide beam;
a carriage operably connected to the guide beam by a fixing mechanism, wherein the carriage is capable of slidable movement along the guide beam;
a cutter-motor unit secured to the carriage whereby the cutter-motor unit is also slidable along the guide beam; and,
wherein the fixing mechanism comprises a trig block for locking the carriage and the cutter-motor unit at a selected position on the guide beam.

2. The saw assembly of claim 1, wherein the fixing mechanism is movable between a released position wherein a clearance is defined between a lower surface of the guide beam and the trig device to allow for movement along the guide beam, and a locked position wherein the trig device engages the lower surface of the guide beam.

3. The saw assembly of claim 2, wherein the fixing mechanism further includes a rotatable rod that extends through a slot in the trig block and a hole in the carriage, wherein an upper end of the rod includes an eccentric wheel and a lower end of the rod includes a handle that is actuated by an operator to move the fixing mechanism between the released and locked positions.

4. The saw assembly of claim 2, wherein the carriage includes at least one bearing mounted on a shaft, and wherein the trig block slidingly engages the shaft during movement between the released position and the locked position.

5. The saw assembly of claim 4, wherein the trig block has a top surface, a first edge and a second edge, wherein the distance between the top surface and the first edge is greater than the distance between the top surface and the second edge, whereby the first and second edges are staggered.

6. The saw assembly of claim 5, wherein the second edge of the trig block engages the shaft in the released position, and the first edge of the trig block engages the shaft in the locked position.

7. The saw assembly of claim 3, wherein actuation of the handle and rod for movement between the released and locked positions causes the eccentric wheel to exert a driving force on the trig block.

8. A saw assembly comprising:
a bridge assembly formed from opposed vertical support arms and a guide beam extending between the support arms;
a carriage slidingly connected to the guide beam by a fixing mechanism having a trig device for locking the carriage at a selected position on the guide beam;
a cutter-motor unit secured to the carriage whereby the cutter-motor unit is also slidable along the guide beam; and,
the fixing mechanism being movable between a released position wherein a clearance is defined between a lower surface of the guide beam and the trig device, and a locked position wherein the trig device engages the lower surface of the guide beam to secure the position of the carriage and cutter-motor unit to the guide beam.

9. The saw assembly of claim 8, wherein the fixing mechanism further includes a rotatable rod that extends through a slot in the trig block and a hole in the carriage, wherein an upper end of the rod includes an eccentric wheel and a lower end of the rod includes a handle that is actuated by an operator to move the fixing mechanism between the released and locked positions.

10. The saw assembly of claim 9, wherein the eccentric wheel has a large radius portion and a small radius portion, and wherein the large radius portion is aligned with a longitudinal axis of the slot of the trig block in the released position.

11. The saw assembly of claim 10, wherein the large radius portion of the eccentric wheel is oriented perpendicular to the longitudinal axis of the slot of the trig block in the locked position.

12. The saw assembly of claim 9, wherein rotation of the handle and rod to arrive at the locked position causes the eccentric wheel to exert a driving force on the trig block which results in movement of the trig block towards the rod and eccentric wheel.

13. The saw assembly of claim 12, wherein the eccentric wheel has a large radius portion and a small radius portion, and wherein the large radius portion is oriented perpendicular to the longitudinal axis of the slot of the trig block in the locked position.

14. The saw assembly of claim 9, wherein the carriage includes at least one bearing mounted on a shaft, and wherein the trig block slidingly engages the shaft during movement between the released position and the locked position.

15. The saw assembly of claim 14, wherein the trig block has a top surface and a first edge staggered from a second edge, and wherein the second edge of the trig block engages the shaft in the released position, and the first edge of the trig block engages the shaft in the locked position.

16. The saw assembly of claim 15, wherein the top surface of the trig block has a brake segment that engages the lower surface of the guide beam in the locked position.

17. A fixing mechanism for use in a table-top saw having a cutter-motor unit slidingly secured to a guide beam by a carriage, the fixing mechanism configured to allow an operator to fix the position the cutter-motor unit on the guide beam, the fixing mechanism comprising:
a trig block having an elongated slot and having a first edge staggered from a second edge;
a rotatable rod that extends through a slot in the trig block, and wherein an upper end of the rod includes an eccentric wheel and a lower end of the rod includes a handle; and,
wherein an operator actuates the handle and rod to move the trig block between a released position wherein a clearance is formed between the trig block and the guide beam and a locked position wherein the trig block engages the guide beam to fix the position of the cutter-motor unit on the guide beam.

18. The fixing mechanism of claim 17, wherein the eccentric wheel has a large radius portion and a small radius portion, and wherein the large radius portion is aligned with a longitudinal axis of the slot of the trig block in the released position.

19. The fixing mechanism of claim 18, wherein the large radius portion of the eccentric wheel is oriented perpendicular to the longitudinal axis of the slot of the trig block in the locked position.

20. The fixing mechanism of claim 17, wherein rotation of the handle and rod to arrive at the locked position causes the eccentric wheel to exert a driving force on the trig block which results in movement of the trig block towards the rod and eccentric wheel.

21. The fixing mechanism of claim 20, wherein the eccentric wheel has a large radius portion and a small radius portion, and wherein the large radius portion is oriented perpendicular to the longitudinal axis of the slot of the trig block in the locked position.

22. The fixing mechanism of claim 17, wherein the trig block has a top surface with a brake segment that engages the guide beam in the locked position.
